(19) United States
(12) Patent Application Publication
(10) Pub. No.: US 2024/0121695 A1
(43) Pub. Date: Apr. 11, 2024

(54) SYSTEMS AND METHODS FOR PERFORMING CONDITIONAL HANDOVER (CHO) FOR A GROUP OF USER EQUIPMENT’S CONNECTED TO A MOVING NODE

(71) Applicant: Samsung Electronics Co, Ltd., Suwon-si (KR)

(72) Inventors: Neha SHARMA, Bangalore (IN); Anshuman NIGAM, Bangalore (IN); Byounghoon JUNG, Suwon-si (KR)

(21) Appl. No.: 18/538,766

(22) Filed: Dec. 13, 2023

Related U.S. Application Data
(63) Continuation of application No. PCT/KR22/10863, filed on Jul. 25, 2022.

(30) Foreign Application Priority Data
Jul. 27, 2021 (IN) 202141033757
Jul. 18, 2022 (IN) 202141033757

(51) Int. Cl. H04W 36/36; H04W 36/00; H04W 36/08; H04W 76/20

(52) U.S. Cl. CPC H04W 36/362; H04W 36/0058; H04W 36/008355; H04W 36/083; H04W 76/20

(57) ABSTRACT

The disclosure relates to a method for performing conditional handover (CHO) for a group of user equipment's (UE) connected to a moving node. The method comprises determining, by a source node, whether a conditional handover (CHO) is configured for the moving node, transmitting, by the source node, a conditional handover request message along with information to one or more target nodes based on the determination, wherein the information indicates a number of a plurality of user equipment (UEs) and the associated capability of each of the plurality of user equipments (UEs) in the group of UEs connected to the moving node, determining whether the one or more target nodes support the conditional handover for the moving node based on the received information, and performing the conditional handover for the moving node based on the determination, wherein performing the conditional handover for the moving node also comprises performing the handover for the group of UEs connected to the moving node.

### CROSS-REFERENCE TO RELATED APPLICATIONS

This application is a continuation of International Application No. PCT/KR2022/010863 designating the United States, filed on Jul. 25, 2022, in the Korean Intellectual Property Receiving Office and claiming priority to Indian Provisional Patent Application No. 202141033757, filed on Jul. 27, 2021, in the Indian Patent Office, and to Indian Complete Patent Application No. 202141033757, filed on Jul. 18, 2022, in the Indian Patent Office, the disclosures of all of which are incorporated by reference herein in their entireties.

### BACKGROUND

### Field

The disclosure relates to a system and a method for performing conditional handover (CHO) for a group of user equipment's (UE) connected to a moving node.

### Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

### SUMMARY

Embodiments of the disclosure provide a method for performing conditional handover (CHO) for a group of user equipment's (UE) connected to a moving node.

According to various example embodiments, a method includes: determining, by a source node, whether a conditional handover (CHO) is configured for a moving node; transmitting, by the source node, a conditional handover request message along with information to one or more target nodes based on the determination, wherein the information indicates a number of a plurality of user equipment (UEs) and the associated capability of each of the plurality of user equipment's (UEs) in the group of UEs; determining whether one or more target nodes support the conditional handover for the group of UEs based on the received information; and performing the conditional handover for the group of UEs based on the determination.

Embodiments of the disclosure provide a method for performing dual active protocol stack (DAPS) handover for a group of user equipment's (UE) connected to a moving node.

According to various example embodiments, the method includes: transmitting, by a source node, a dual-active protocol stack (DAPS) handover request message along with information to one or more target nodes, wherein the information indicates a number of a plurality of user equipment's (UEs) and associated capability of the plurality of user equipment's (UEs) in the group of UEs; determining whether one or more target nodes support the dual active protocol stack (DAPS) handover for the group of UEs based on the received information; and performing the dual active protocol stack (DAPS) handover for the user equipment's (UE) group based on the determination.

Embodiments of the disclosure provide a moving node for performing handover (HO) for a group of UEs in a wireless communication system. The moving node includes: a transceiver and a controller configured to control the transceiver. The controller is configured to: determine whether a conditional handover (CHO) is configured for the moving node; transmit a conditional handover request message along with information to one or more target nodes based on the determination, wherein the information indicates the number of a plurality of user equipment (UEs) and the associated capability of each of the plurality of user equipment (UEs) in the user equipment (UE) group. The controller is further configured to determine whether one or more target nodes support the conditional handover for the group of UEs based on the received information; perform the conditional handover for the user equipment (UE) group based on the determination.

Embodiments of the disclosure provide a moving node for performing a dual active protocol stack (DAPS) for a user equipment (UE) group in a wireless communication system. The moving node includes: a transceiver and a controller configured to control the transceiver. The controller is configured to: transmit a dual-active protocol stack (DAPS) handover request message along with information to one or more target nodes, wherein the information indicates a number of a plurality of user equipment (UEs) and associated capability of the plurality of user equipment's (UEs) in the group of UEs. The controller is configured: to determine whether one or more target nodes support the dual active protocol stack (DAPS) handover for the user equipment's (UE) group based on the received information and perform the dual active protocol stack (DAPS) handover for the group of UEs based on the determination.

### BRIEF DESCRIPTION OF THE DRAWINGS

These and other features, aspects, and advantages of certain embodiments of the present disclosure will be more apparent from the following detailed description, taken in conjunction with the accompanying drawings in which:

FIG. 1 is a diagram illustrating an existing network architecture supporting a moving network;

FIGS. 2A and 2B are diagrams illustrating an existing handover mechanism for a moving network;

FIG. 3 is a flowchart illustrating an example method for performing conditional handover (CHO) for user equipment (UE) group connected to a moving node, according to various embodiments;

FIG. 4 is a flowchart illustrating an example decision mechanism for configuring conditional handover for a moving node, according to various embodiments;

FIG. 5 is a flowchart illustrating an example method for evaluating the CHO and the decision to move to the new cell, according to various embodiments;

FIG. 6 is a signal flow diagram illustrating example signal flow between a UE and core network during a conditional handover, according to various embodiments;

FIG. 7 is a flowchart illustrating an example method for performing handover for a group of UEs connected to a moving node, according to various embodiments;

FIG. 8 is a signal flow diagram illustrating example signal flow a UE and core network during a handover, according to various embodiments;

FIG. 9 is a flowchart illustrating an example method for performing dual active protocol stack (DAPS) handover for a group of UEs connected to a moving node, according to various embodiments;

FIG. 10 is a signal flow diagram illustrating example signal flow between a UE and core network during a dual active protocol stack (DAPS) handover, according to various embodiments;

FIG. 11 is a diagram illustrating an example network node, according to various embodiments; and

FIGS. 12 and 13 are block diagrams illustrating example configurations of a terminal in a wireless communication system, according to various embodiments.

### DETAILED DESCRIPTION

To further clarify the advantages and features of the present disclosure, a more particular description will be rendered by reference to various example embodiments, illustrated in the appended drawings. It will be appreciated that these drawings illustrate example embodiments and are therefore not to be considered limiting its scope. The disclosure will be described and explained with additional specificity and detail with the accompanying drawings.

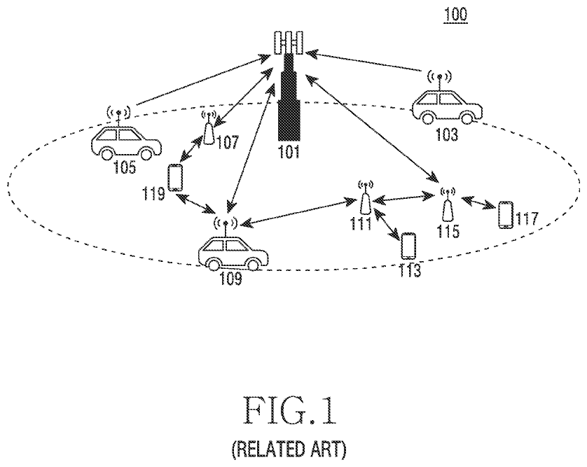

FIG. 1 is a diagram 100 illustrating an existing network architecture supporting a moving network. The moving network may include a satellite or non-terrestrial system, a moving integrated access and backhaul (IAB) or relay, a moving gNB or eNB, and an unmanned aerial vehicle (UAV) or a drone or a high-altitude platform system (HAPS). The use case of the moving network includes In-vehicle IAB access to the end-user inside a vehicle, a moving cell site, or moving nodes to enhance outdoor access capacity, and flexible and dynamic deployment of the IAB nodes, e.g., mounted on trailers, drones or balloons, provide additional coverage/capacity for special events, temporary traffic hot-spots. As shown in FIG. 1, multiple user equipment (UE) 119,113, and 117 is connected to a mobile node 103,105,107, 109, 111, and 115 which is connected to a donor or gNB or NW node 101.

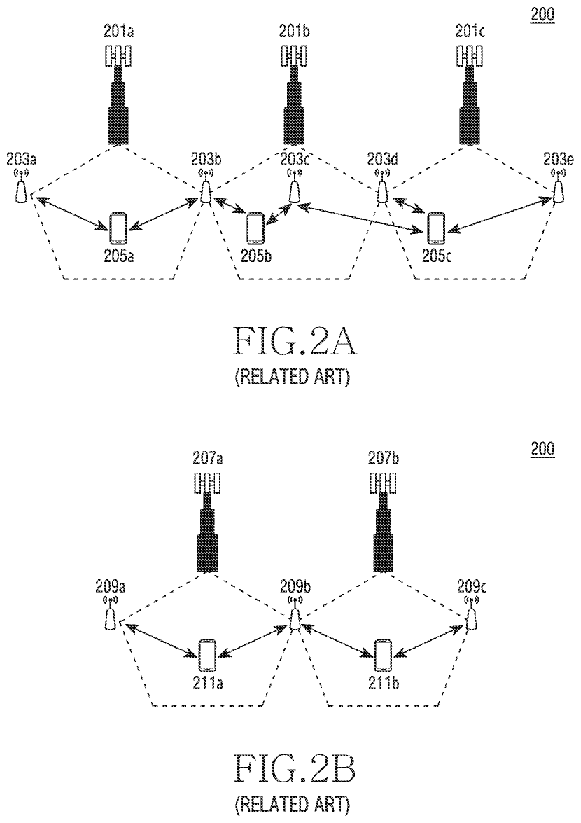

FIGS. 2A and 2B are diagrams 200 illustrating an existing handover mechanism for a moving network. Multiple user equipment (UE) is connected to a moving node. Further, the moving node is connected to a donor or gNB or NW node. The moving nodes 205a, 205b, and 205c (which may be referred to as 205a-c) are connected to one of the fixed IAB nodes 203a, 203b, 203c, 203d, 203e (which may be referred to as 203a-e), which are connected through an IAB donor node 201a, 201b, and 201c as shown in FIG. 2A. The moving node 205a-c performs frequent handovers due to its mobility. During inter-donor (CU) handover e.g., from 207a to 207b, even though the UEs 211a and 211b associated with an IAB node 209a, 209b, 209c (which may be referred to as 209a-c) may not experience access node change, then also all such UEs 211a, 211b would undergo a handover procedure. This handover procedure is highly inefficient from a signalling perspective and may also increase handover failures as shown in FIG. 2B. If a new donor does not have a context or cannot handle all the UEs then all the UE will face a radio link failure (RLF), and the connection will be lost. This can result in a signalling overhead, handover failure, and user plane interruption. For example, the users inside a public vehicle often exert excessive load on the network due to large group handovers. Each UE in the public vehicle performs handover with a network which increases signalling load, latency, interruption, and reduced HO success rate. Therefore, there is a need for a mechanism to overcome the above-discussed problems in the art.

It should be understood at the outset that although illustrative implementations of the various example embodiments of the present disclosure are illustrated below, the present disclosure may be implemented using any number of techniques, whether currently known or in existence. The present disclosure should in no way be limited to the illustrative implementations, drawings, and techniques illustrated below, including the example design and implementations illustrated and described herein, but may be modified within the scope of the appended claims along with their full scope of equivalents.

The term “some” as used herein may include “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” may refer, for example, to “no embodiment, or one embodiment, or more than one embodiment, or all embodiments.”

The terminology and structure employed herein is for describing, teaching, and illuminating various embodiments and their specific features and elements and does not limit, restrict or reduce the spirit and scope of the claims or their equivalents.

For example, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language such as “must comprise” or “needs to include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do not preclude there being none of that feature or element unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having an ordinary skill in the art.

Embodiments of the present disclosure will be described below in greater detail with reference to the accompanying drawings.

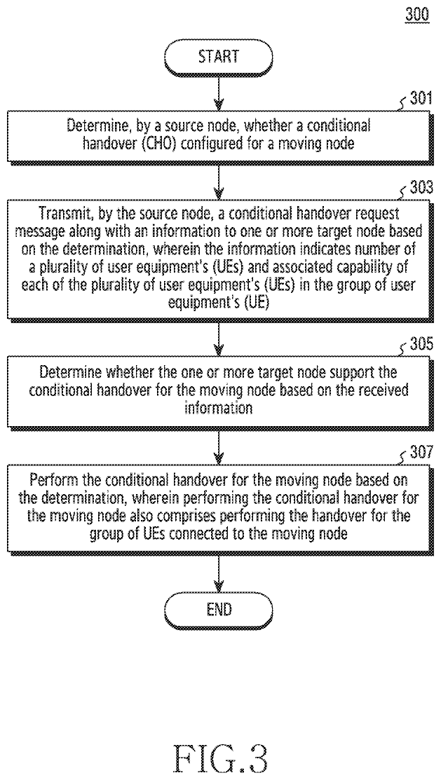

FIG. 3 is a flowchart 300 illustrating an example method for performing conditional handover (CHO) for user equipment (UE) group connected to a moving node, according to various embodiments. The method may include determining at operation 301, by a source node, whether a conditional handover (CHO) is configured for the moving node. Moving node may act as a user equipment, which is attached to the source node. Further, the moving node also acts as a UE which is attached to the source node. Further, the moving node also acts as a moving network for the group of UE' s connected to it. The source node may receive a measurement report from the moving node. Based on the received measurement report, the source node may determine the number of the plurality of user equipment (UEs) in the user equipment's (UE) group, the associated capability of each of the plurality of user equipment's (UEs) in the group of UEs connected to the moving node, and functionality of the moving node.

The method may include transmitting at operation 303, by the source node, a conditional handover request message along with information to one or more target nodes based on the determination. The information indicates the number of a plurality of user equipment (UEs), the associated capability of each of the plurality of user equipment (UEs) in the user equipment (UE) group, and the functionality of the moving node.

The method 300 may include determining at operation 305, whether the one or more target nodes support the conditional handover for the group of UEs based on the received information.

One or more target nodes may receive the conditional handover request message along with information. Then, one or more target nodes may determine whether it can support the conditional handover for the group of UEs.

The method 300 may include performing at operation307, the conditional handover for the group of UEs based on the above determination. According to an embodiment, the performing the conditional handover for the moving node also comprises performing the handover for the group of UEs connected to the moving node. Now, if at least one target node can support the number of a plurality of user equipment (UEs), the associated capability of each of the plurality of user equipment (UEs) in the user equipment (UE) group, and the functionality of the moving node, then the conditional handover for the group of UEs may be performed by the target node.

In an embodiment, the conditional handover configuration may apply to the moving node. The method may include determining whether a physical cell ID (PCI) for the moving node or any configuration associated with the source node or the group of UEs, is changed. Thereafter, the source node may transmit an RRCReconfiguration message with an indication of new PCI to the group of UEs based on the determination. Then, the user equipment (UEs) group may apply the received RRCreconfiguration. Subsequently, the group of UEs may send an RRC reconfiguration complete message to the source node.

In an embodiment, the target node may determine whether all or some of the plurality of UEs or the moving node, or the source node acting as a UE is not supported. Thereafter, the target node may reject the conditional handover request. Further, the target node may send a conditional handover request rejection message to the source node. Further, the target node may transmit a conditional handover message indicating the number of the user equipment (UEs) it can support. Thereafter, the source node may decide whether to continue with the conditional handover based on the received conditional handover message.

In an embodiment, when a group of UEs perform handover, the source node may transmit a handover request message along with information to one or more target node. The information indicates a number of a plurality of user equipment (UEs) and the associated capability of the plurality of user equipment (UEs) in the group of UEs. Thereafter, one or more target nodes may determine whether one target node from one or more target nodes can support the handover (HO) for the group of UEs based on the received information. Furthermore, the method may include performing the handover for the group of UEs. A target node from one or more target nodes may accept the handover request message. Further, the target node may perform the admission control of the moving node and the group of UEs. The target node may send an acknowledgment message indicating the handover (HO) is completed. The acknowledgment message includes the RRCreconfiguration message. Further, the source node may forward the received RRCreconfiguration message to the moving node. The handover for the user equipment (UE) group may be configured based on the received RRCreconfiguration message.

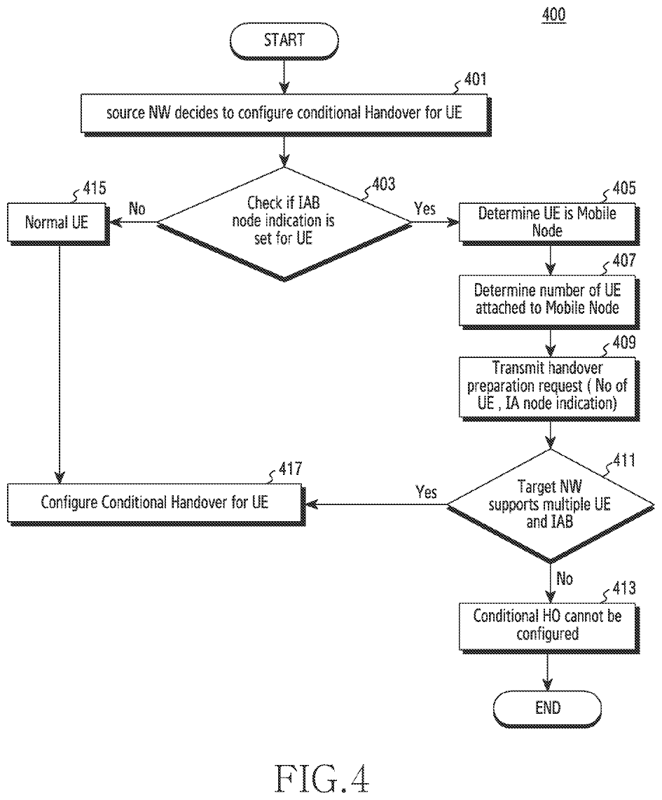

FIG. 4 is a flowchart 400 illustrating an example decision mechanism for configuring conditional handover for a moving node, according various embodiments. At operation 401, a source network node may decide to configure conditional handover for user equipment. At operation 403, the source node may check if the IAB node indication is set for the UE. If the indication is not set for the UE, the IAB may continue to work as a normal UE at operation 415. The method 400 may include determining at operation 405, that the UE node is mobile. At operation 407, the method 400 may include determining the number of the UE attached to the moving node. The method may include transmitting at operation 409, a handover request message indicating the number of the UE and IAB node indication for handover, to one or more target node. This operation corresponds to operation 303. The method may include determining at operation 411, whether the target network supports the multiple UE and IAB. This operation corresponds to operation 305. If the target network supports the handover, the method may include configuring at operation 417, the conditional handover for the UE. This operation corresponds to operation 307. Further, if the target network cannot support handover, then the conditional handover cannot be configured for the moving node at operation 413.

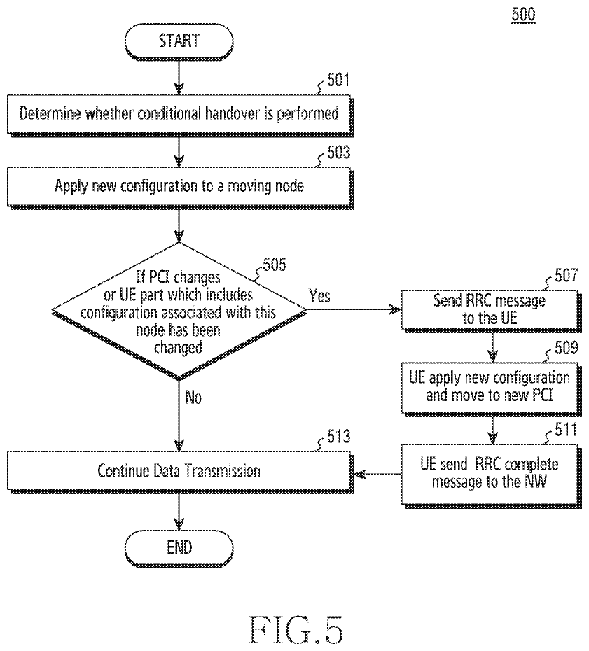

FIG. 5 is a flowchart 500 illustrating an example method for evaluating a conditional handover and the decision to move to the new cell, according to various embodiments. The method may include determining at operation 501, whether a conditional handover is performed. The method may include applying at operation 503, a new configuration for a moving node. At operation 505, checking whether a physical cell ID (PCI) for an IAB node distributed unit (DU) or a centralized unit (CU) and distributed unit (DU), or gNB, or any combination of the network has been changed or user equipment (UE) part which includes configuration associated with this node has been changed, then the IAB node should transfer the same. The NW sends RRC reconfiguration with the indication of new PCI at operation 507. The UE may apply a new configuration and move to new PCI at operation 509. The UE may send a radio resource control (RRC) reconfiguration complete message to the network operation step 511. The UE moves to a new cell, and will not face a radio link failure (RLF) at operation 513.

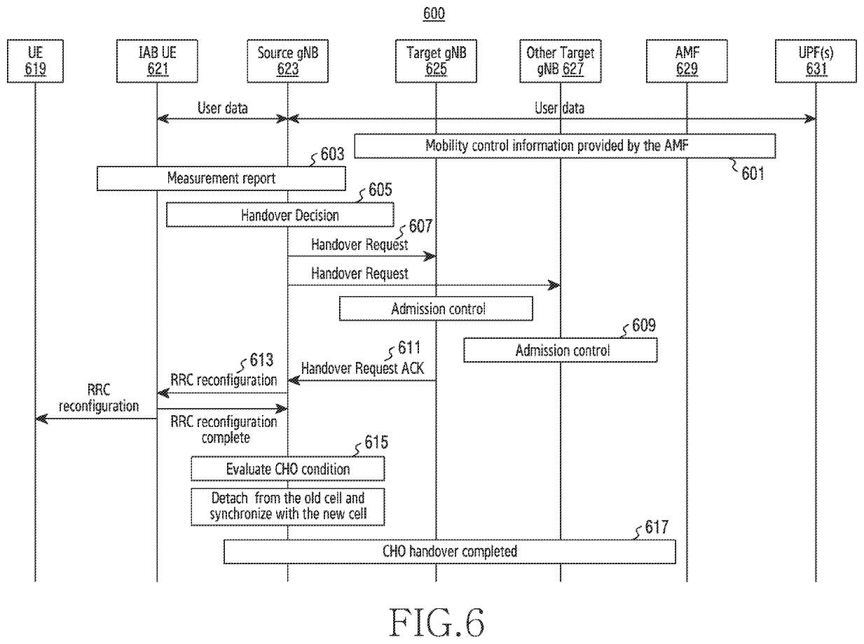

FIG. 6 is a signal flow diagram 1000 illustrating an example procedure of performing conditional handover for a group of UEs connected to a moving node according to various embodiments. At 601, a source node 623 receives mobility information from an access and mobility management function (AMF) 629. The source gNB 623 receives measurement reports at 603. At 605, the source gNB 623 decides to use CHO based on the indication of the IAB node 621.

At 607, the source gNB 623 issues a handover request message to one or more candidate gNBs 623 or target gNBs 625 or other potential target gNBs 627. It indicates the IAB node 621 indications, the number of UE associated with it, and/or details or UE context.

At 609, the target node 625 may perform admission control. If all or some of the UEs served by the IAB node 621 or moving node or part of the IAB node or gNB node acting as UE cannot be supported by the target node, then it may reject the request and send the reject the message. The target node 625 can mention in the handover ACK message number of UEs it can support. Based on this. the source node 623 can decide whether it can continue with the handover request or not. Slice-aware admission control shall be performed if the slice information is sent to the target gNB 625. If PDU sessions are associated with non-supported slices the target gNB 625 shall reject such PDU sessions.

At 611, the candidate gNB sends a handover request to acknowledge the message including the configuration of the CHO candidate cell to the source gNB 623. It can also share the configuration of UE attached to this IAB node 621. For example, the changed physical cell ID (PCI) information or any changed configuration. Also, it provides the configuration for the network part which can be based on a distributed unit(DU) or a centralized unit (CU), and distributed unit (DU), or gNB which can be new PCI or configuration to set up an F1 application protocol (FLAP), a control plane of an F1 (F1*C), an operation, administration, and maintenance (OAM) configuration to set up the distributed unit (DU) or a centralized unit (CU) and distributed unit (DU), or gNB, IAB-node DU part setup, routing update and the like.

At 613, the source gNB sends a radio resource control (RRC) reconfiguration message to the IAB 619 UE, containing the configuration of CHO candidate cell(s) and CHO execution condition(s). It also provides the configuration for IAB node like modification, setup or release of backhaul RLC channel, F1-AP or F1* configuration, new PCI for NW part for IAB, OAM configuration to set up the distributed unit (DU) or a centralized unit (CU) and distributed unit (DU), or gNB, the IAB-node DU part setup, routing update and change in UE configuration if needed. This may also contain a new mapping of the bearer to the RLC backhaul channel.

At 613, the UE sends an RRC reconfiguration Complete message to the source gNB. The UE maintains a connection with source gNB after receiving CHO configuration and starts evaluating the CHO execution conditions for the candidate cell(s) at 615. If at least one CHO candidate cell satisfies the corresponding CHO execution condition, the UE detaches from the source gNB, applies the stored corresponding configuration for that selected candidate cell, and synchronizes to that candidate cell at 617. THE IAB UE can also configure the new PCI for the network part of the IAB node if provided by gNB. Once PCI changes then it should inform the UE also which are served through this moving network.

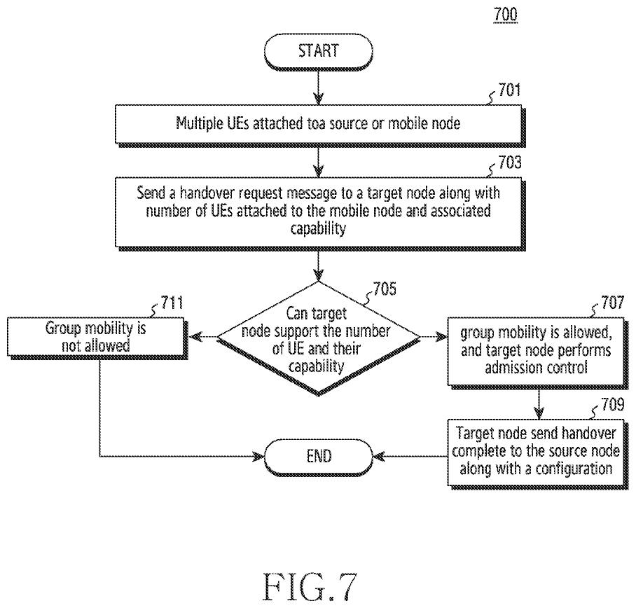

FIG. 7 illustrates a flowchart 700 illustrating an exmaple method for performing handover for a group of UEs connected to a moving node, according to various embodiments. The method may include sending at operation 701, by a source node, a number of UEs attached to it, and their capability to a target node. At operation 703, the source gNB initiates handover and issues a handover request over an Xn interface or F1 interface. It will have new IEs like the number of UE, and UE capability. At operation 705, the target node determines whether it can support the number of UE and the UE capability. If the target node can allow admission of multiple UEs then only the target node accepts the handover request message and send a response for the same to the source node at operation 707. The target gNB performs admission control and provides a new radio resource control (RRC) configuration as part of a handover request acknowledgment. At operation 709, the source gNB provides the radio resource control (RRC) configuration to the mobile UE by forwarding the RRCeconfiguration message received in the handover request acknowledge. If the target node does not support the number of UE, then a group mobility is not allowed at operation 711.

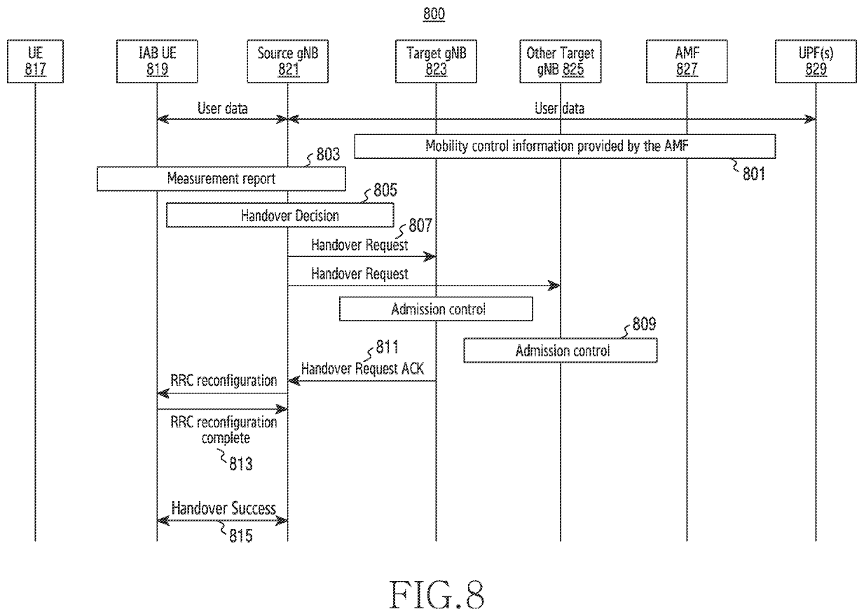

FIG. 8 is a signal flow diagram 1000 illustrating an example procedure of performing handover for a group of UEs connected to a moving node, according to various embodiments. At 801, a source node 821 receives mobility information from an access & mobility management function (AMF) 827. At 803, the source gNB 821 receives measurement reports. At 805, the source gNB 821 decides on a handover. At 807, the source node 821 may transmit a handover request message along with information to one or more target nodes 823, 825. This corresponds to operation 701. The information indicates the number of a plurality of user equipment (UEs) and the associated capability of the plurality of user equipment (UEs) in the user equipment (UE) group. At 809, the target node 823 performs admission control of the moving node 819 and the group of UEs. At 811, the target node 823 may send an acknowledgment message indicating the handover (HO) is completed. The acknowledgment message includes an RRCreconfiguration message. At 813, forwarding, by the source node, the RRCreconfiguration message to the moving node 819. At 815, configuring the handover for the user equipment (UE) group based on the received RRCreconfiguration message.

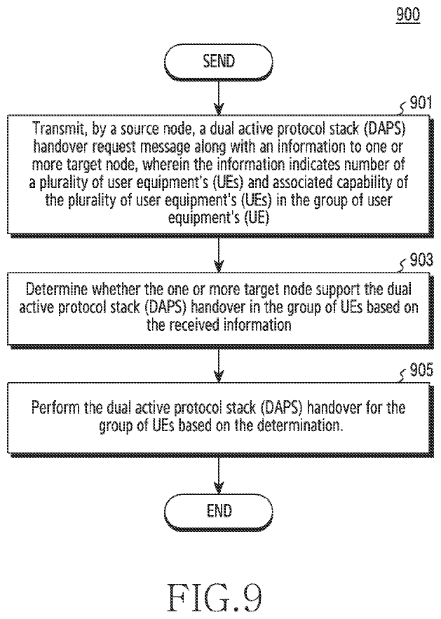

FIG. 9 is a flowchart 900 illustrating an example method for performing dual active protocol stack (DAPS) handover for a group of UEs connected to a moving node, according to various embodiments. The DAPS handover is a handover procedure that maintains the source gNB connection after the reception of an RRC message for handover and until releasing the source node after successful random access to the target node.

The method 900 may include transmitting at operation 901, by a source node, a dual-active protocol stack (DAPS) handover request message along with information to one or more target nodes. The information indicates the number of a plurality of user equipment (UEs) and the associated capability of the plurality of user equipment (UEs) in the user equipment (UE) group.

The method 900 may include determining at operation 903, whether the one or more target nodes support the dual active protocol stack (DAPS) handover for the group of UEs based on the received information.

The method 900 may include performing at operation 905, the dual active protocol stack (DAPS) handover for the group of UEs, if at least one target node can support the dual active protocol stack (DAPS) handover. In an embodiment, the method may include creating a medium access control (MAC) entity for the target node. Thereafter, establishing a radio link control (RLC) entity and an associated dedicated traffic channel (DTCH) logical channel, backhaul logical channel or radio link control (RLC) entity, backhaul logical channel (BH-RLC-Channel Config), and the corresponding RLC configuration (RLC-Config) for the target for each DRB or backhaul RLC channel configured with DAPS. Reconfiguring a packet data convergence protocol (PDCP) entity with separate security and a ROHC functions for the source node and the target node. The method may include associating the reconfigured PDCP with the RLC entities. The RLC entities may be configured by the source node and target node. The method may include retaining the rest of the source node configurations until the release of the source node.

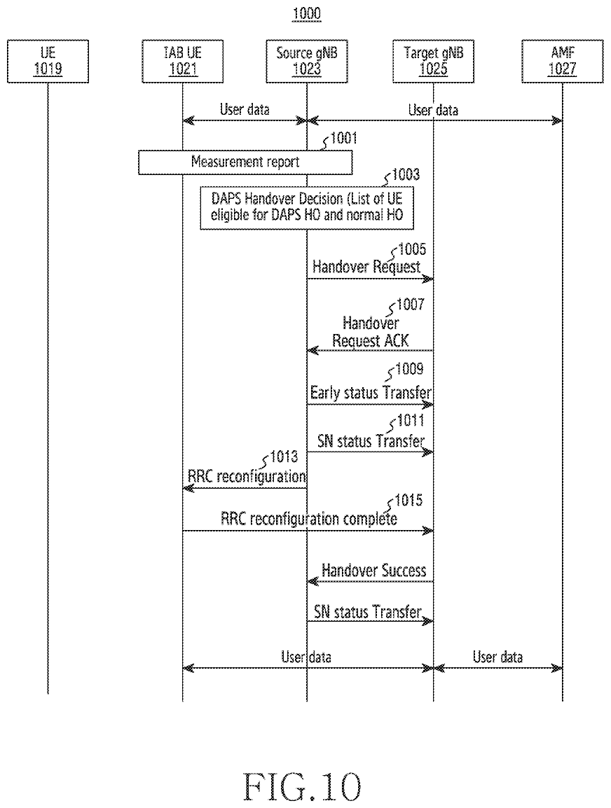

FIG. 10 is a signal flow diagram 1000 illustrating an example procedure of performing dual active protocol stack (DAPS) handover for a group of UEs connected to a moving node, according to various embodiments. At 1001, a source gNB 1023 receives a measurement report. At 1003, the source gNB 1023 decides for the DAPS handover by considering the number of UE eligible for the DAPS HO and the number of UE eligible for a normal handover.

At 1005, the source node 1023 may transmit a dual-active protocol stack (DAPS) handover request message along with information to one or more target node 1025. This corresponds to operation 901. The information indicates the number of a plurality of user equipment (UEs) 1019 and the associated capability of the plurality of user equipment (UEs) in the group of UEs. At 1007, a DAPS handover request ACK message is received. At 1009, early status transfer between the Mobile IAB UE 1021 SN and the SN of connected UE 1019 for the DAPS HO. At 1011, the source node 1023 may perform an SN status transfer. At 1013, an RRC reconfiguration is transmitted. The RRC reconfiguration may include the number of UE agreed for the DAPS and the number of the UE agreed for the normal HO. At 1015 the RRC reconfiguration is complete.

In an example embodiment, a moving node for performing handover (HO) for a group of UEs in a wireless communication system, wherein the group of UEs is connected to the moving node is provided. Further, the moving node also acts as a UE which is attached to the source node. Further, the moving node also acts as a moving network for the group of UE' s connected to it. The moving node may include a transceiver and a controller configured to control the transceiver. The controller may be configured to determine whether a conditional handover (CHO) is configured for the moving node. The controller may be configured to receive a measurement report from the moving node. The controller may be configured to determine at one of the numbers of the plurality of user equipment (UEs) in the group of UEs, the associated capability of each of the plurality of user equipment (UEs) and determining the functionality of the moving node based on the received measurement report.

In an example embodiment, the controller may be configured to transmit a conditional handover request message along with information to one or more target nodes based on the determination. The information indicates the number of a plurality of user equipment (UEs) and the associated capability of each of the plurality of user equipment (UEs) in the user equipment (UE) group. One or more target nodes may receive the conditional handover request message. Thereafter, the controller may determine whether one or more target nodes support the conditional handover for the group of UEs based on the received information. If one of the target nodes from one or more target nodes can support, then the controller may be configured to perform the conditional handover for the group of UEs.

In an example embodiment, the controller may be configured to apply the conditional handover configuration for the moving node. Then, the controller may be configured to determine whether a physical cell ID (PCI) for the moving node or any configuration associated with the source node or the group of UEs is changed. The controller may be configured to transmit an RRCReconfiguration message with an indication of new PCI to the group of UEs based on the determination. The controller may be configured to apply the received RRCReconfiguration. The controller may be configured to send an RRC reconfiguration complete message to the source node.

In an example embodiment, the controller may be configured to determine whether all or some of the plurality of UEs or the moving node or the source node acting as a UE is not supported by the target node. The controller may be configured to reject the conditional handover request based on the above determination. The controller may be configured to send a conditional handover request rejection message to the source node.

In an example embodiment, the controller may be configured to transmit a conditional handover message indicating the number of the user equipment (UEs) supported by the target node. The controller may be configured to decide whether to continue with the conditional handover based on the received conditional handover message.

In an example embodiment, when a group of UEs perform handover, the controller may be configured to transmit a handover request message along with information to one or more target node. The information indicates the number of a plurality of user equipment (UEs) and the associated capability of the plurality of user equipment (UEs) in the group of UEs. Then, the controller may be configured to determine whether one or more target nodes support the handover (HO) for the group of UEs based on the received information. Thereafter, the controller may be configured to perform the handover for the group of UEs based on the determination.

In an example embodiment, the controller may be configured to accept from the one or more target nodes, the handover request message. The controller may be configured to perform admission control of the moving node and the group of UEs. The controller may be configured to send an acknowledgment message indicating the handover (HO) is completed. In an implementation, the acknowledgment message includes an RRCreconfiguration message. Thereafter, the controller may be configured to forward the RRCreconfiguration message to the moving node. The controller may be configured to configure the handover for the user equipment (UE) group based on the received RRCreconfiguration message.

In an example embodiment, a moving node for performing dual active protocol stack (DAPS) for a group of UEs in a wireless communication system. The moving node may include a transceiver and a controller configured to control the transceiver. The controller may be configured to transmit a dual-active protocol stack (DAPS) handover request message along with information to one or more target nodes. The information indicates the number of a plurality of user equipment (UEs) and the associated capability of the plurality of user equipment (UEs) in the user equipment (UE) group. The controller may be configured to determine whether one or more target nodes support the dual active protocol stack (DAPS) handover for the group of UEs based on the received information. Further, the controller may be configured to perform the dual active protocol stack (DAPS) handover for the group of UEs based on the determination.

In an example embodiment, the controller may be configured to create a medium access control (MAC) entity for the target node. The controller may be configured to establish an RLC entity and an associated DTCH logical channel, backhaul logical channel or RLC entity, backhaul logical channel (BH-RLC-ChannelConfig), and the corresponding RLC configuration (RLC-Config) for the target node for each DRB or backhaul RLC channel configured with DAPS. The controller may be configured to reconfigure a PDCP entity with separate security and ROHC functions for the source node and the target node. The controller may be configured to associate the reconfigured PDCP with the RLC entities, wherein the RLC entities are configured by the source node and target node. The controller may be configured to retain the rest of the source node configurations until the release of the source node.

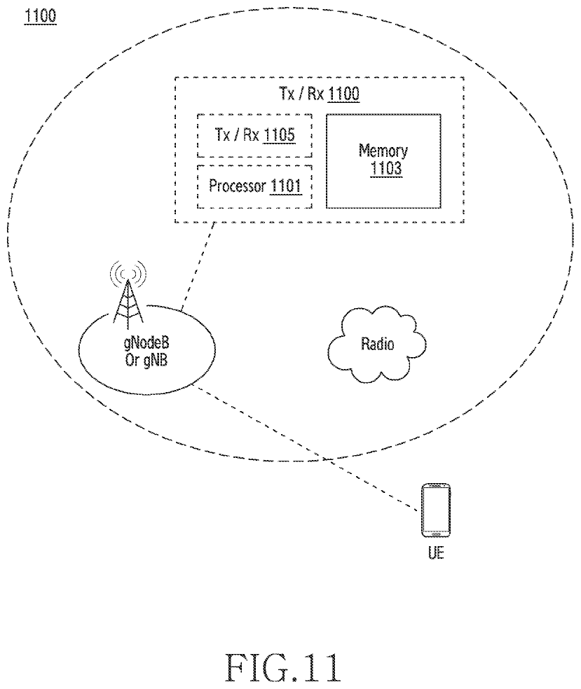

FIG. 11 is a diagram illustrating an example network node, according to various embodiments. The network node 1100 may include a communication unit (e.g., including communication circuitry) 1105 (e.g., communicator or communication interface), a memory unit (e.g., including a memory) 1103 (e.g., storage), and at least one processor (e.g., including processing circuitry) 1101. Further, the network node 1100 may also include the Cloud-RAN (C-RAN), a Central Unit (CU), a core network (NW), a distributed unit (DU), a TRP controller, or any other possible network (NW) entity. The communication unit 1105 may include various communication circuitry and perform functions for transmitting and receiving signals via a wireless channel.

In an example, the processor 1101 may be a single processing unit or a number of units, all of which could include multiple computing units. The processor 1101 may be implemented as one or more microprocessors, microcomputers, microcontrollers, digital signal processors, central processing units, state machines, logic circuitries, and/or any devices that manipulate signals based on operational instructions. Among other capabilities, the processor 1101 is configured to fetch and execute computer-readable instructions and data stored in the memory. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning.

The memory may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

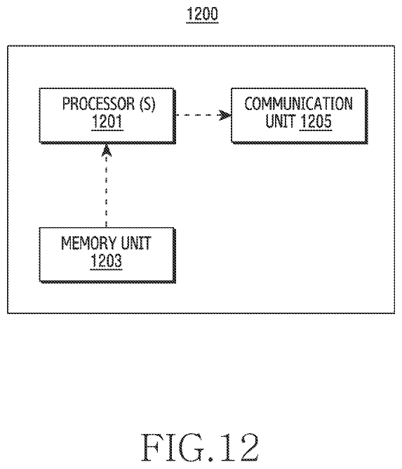

FIG. 12 is a block diagram illustrating an example configuration of a terminal 1200 in a wireless communication system according to various embodiments. The configuration of FIG. 12 may be understood as a part of the configuration of terminal 1200. Hereinafter, it is understood that terms including “unit” or “er” at the end may refer to the unit for processing at least one function or operation and may be implemented in hardware, software, or a combination of hardware and software. Terminal 1200 may include a communication unit (e.g., including communication circuitry) 1205 (e.g., communicator or communication interface), a storage unit 1203 (e.g., a memory or storage), and at least one processor (e.g., including processing circuitry) 1201.

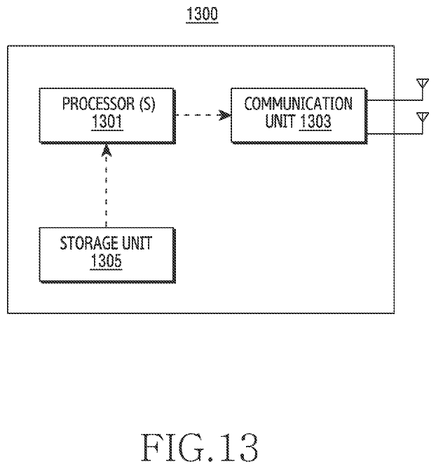

Referring to FIG. 13, terminal 1300 may include a communication unit (e.g., including communication circuitry) 1303 (e.g., communicator or communication interface), a storage unit 1305 (e.g., a memory or storage), and at least one processor (e.g., including processing circuitry) 1301. By way of example, the terminal 1300 may be a User Equipment, such as a cellular phone or other devices that communicate over a plurality of cellular networks (such as a 4G, a 5G or pre-5G network or any future wireless communication network). The communication unit 1303 may perform functions for transmitting and receiving signals via a wireless channel.

Unless otherwise defined, all technical and scientific terms used herein have the same meaning as commonly understood by one of ordinary skilled in the art to which the disclosure belongs. The system, methods, and examples provided herein are illustrative only and not intended to be limiting.

While specific language has been used to describe the disclosure, any limitations arising on account of the same are not intended. As would be apparent to a person in the art, various working modifications may be made to the method in order to implement the concept of the disclosure as taught herein. The drawings and the forgoing description give examples of embodiments. Those skilled in the art will appreciate that one or more of the described elements may well be combined into a single functional element. Certain elements may be split into multiple functional elements. Elements from one embodiment may be added to another embodiment. For example, orders of processes described herein may be changed and are not limited to the manner described herein.

Moreover, the actions of any signal diagram or flowchart need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the disclosure or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While the disclosure has been illustrated and described with reference to various example embodiments, it will be understood that the various example embodiments are intended to be illustrative, not limiting. It will be further understood by those skilled in the art, as set forth above, that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for performing conditional handover for a group of user equipment's (UE) connected to a moving node, the method comprising:
determining, by a source node, whether a conditional handover (CHO) is configured for the moving node;
transmitting, by the source node, a conditional handover request message along with information to one or more target nodes based on the determination, wherein the information includes a number of a plurality of user equipment (UEs) and associated capability of each of the plurality of UEs in the group of UEs connected to the moving node;
determining whether the one or more target nodes support the conditional handover for the moving node based on the received information; and
performing the conditional handover for the moving node based on the determination, wherein performing the conditional handover for the moving node includes performing the handover for the group of UEs connected to the moving node.

2. The method of claim 1,
wherein the moving node act as a UE attached to the source node, wherein the moving node further acts as a moving network for the group of UEs connected to the moving node.

3. The method of claim 1,
wherein determining, by the source node, whether a conditional handover can be configured for the moving node comprises:
receiving, by the source node, a measurement report from the moving node; and
determining at one of a number of the plurality of user equipment UE in group of UEs, the associated capability of each of the plurality of UEs, and a functionality of the moving node based on the received measurement report.

4. The method of claim 1,
wherein performing the conditional handover for the group of UEs comprises:
applying the conditional handover configuration for the moving node;
determining whether a physical cell ID (PCI) for the moving node or any configuration associated with the source node or the group of UEs, is changed;
transmitting, by the source node, an RRCReconfiguration message with an indication of new PCI to the group of UEs based on the determination;
applying, by the group of UEs, the received RRCReconfiguration; and
sending an radio resource control (RRC) reconfiguration complete message to the source node.

5. The method of claim 1, further comprises performing admission control for the group of UEs by:
determining whether all or some of the plurality of UEs or the moving node or the source node acting as a UE is not supported by the target node;
rejecting the conditional handover request based on the determination; and
sending a conditional handover request rejection message to the source node.

6. The method of claim 5, further comprises:
transmitting, by the target node, a conditional handover message indicating the number of the UEs supported by the target node; and
deciding, by the source node, whether to continue with the conditional handover based on the received conditional handover message.

7. The method of claim 1,
wherein performing handover for the group of UEs comprises:
transmitting, by the source node, a handover request message along with information to one or more target nodes, wherein the information indicates the number of a plurality of UE and associated capability of the plurality of UEs in the group of UEs;
determining whether the one or more target nodes support the handover for the group of UEs based on the received information; and
performing the handover for the group of UEs connected to the moving node based on the determination.

8. The method of claim 7,
wherein performing the handover for the group of UEs connected to the moving node comprises:
accepting, by a target node from the one or more target nodes, the handover request message;
performing, by the target node, admission control of the moving node and the group of UEs connected to the moving node;
sending, by the target node, an acknowledgment message indicating the handover is completed, wherein the acknowledgment message includes an RRCreconfiguration message;
forwarding, by the source node, the RRCreconfiguration message to the moving node; and
configuring the handover for the group of UEs based on the received RRCreconfiguration message.

9. A method for performing dual active protocol stack (DAPS) handover for a group of user equipments (UEs) connected to a moving node, the method comprising:
transmitting, by a source node, a DAPS handover request message along with information to one or more target nodes, wherein the information indicates a number of a plurality of UEs and associated capability of the plurality of UEs in the group of UEs;
determining whether the one or more target nodes support the DAPS handover for the group of UEs based on the received information; and
performing the DAPS handover for the group of UEs based on the determination.

10. The method of claim 9,
wherein performing the DAPS handover comprises:
creating a medium access control (MAC) entity for the target node;
establishing a radio link control (RLC) entity and an associated dedicated traffic channel (DTCH) logical channel, backhaul logical channel or radio link control (RLC) entity, backhaul logical channel (BH-RLC-ChannelConfig), and the corresponding RLC configuration (RLC-Config) for the target for each data radio bearer (DRB) or backhaul RLC channel;
reconfiguring a packet data convergence protocol (PDCP) entity with separate security and a robust header compression (ROHC) functions for the source node and the target node;
associating the reconfigured PDCP with the RLC entities, wherein the RLC entities are configured by the source node and target node; and
retaining the rest of the source node configurations until the release of the source node.

11. A moving node configured to perform handover for a group of User Equipments (UEs) in a wireless communication system, wherein the group of UEs is connected to the moving node, the moving node comprising:
a transceiver; and
a controller configured to control the transceiver,
wherein the controller is configured to:
determine, by a source node, whether a conditional handover is configured for the moving node;
transmit, by the source node, a conditional handover request message along with information to one or more target nodes based on the determination, wherein the information indicates the number of a plurality of user equipment (UE) and the associated capability of each of the plurality of user equipments (UEs) in the group of UEs connected to the moving node;
determine whether the one or more target nodes support the conditional handover for the moving node based on the received information; and
perform the conditional handover for the moving node based on the determination, wherein performing the conditional handover for the moving node also comprises performing the handover for the group of UEs connected to the moving node.

12. The moving node of claim 11,
wherein the moving node is configured to act as a UE, attached to the source node, wherein the moving node is further configured to act as a moving network for the group of UEs connected to the moving node for the group of UEs connected to the moving node.

13. The moving node of claim 11,
wherein the controller, for determining whether a conditional handover can be configured for the moving node, is configured to:
receive, by the source node, a measurement report from the moving node; and
determine at one of a number of the plurality of UEs in the group of UEs, the associated capability of each of the plurality of UEs, and a functionality of the moving node based on the received measurement report.

14. The moving node of claim 11,
wherein the controller, for performing the conditional handover for the group of UEs, is configured to:
apply the conditional handover configuration for the moving node;
determine whether a physical cell ID (PCI) for the moving node or any configuration associated with the source node or the group of UEs, is changed;
transmit, by the source node, the RRCReconfiguration message with an indication of new PCI to the group of UEs based on the determination;
apply, by the group of UEs, the received RRCReconfiguration; and
send an radio resource control (RRC) reconfiguration complete message to the source node.

15. The moving node of claim 11,
wherein the controller, for performing admission control for the group of UEs, is configured to:
determine, by the target node, whether all or some of the plurality of UEs or the moving node or the source node acting as a UE is not supported;
reject the conditional handover request based on the determination; and
send a conditional handover request rejection message to the source node.

16. The moving node of claim 11,
wherein the controller is further configured to:
transmit, by the target node, a conditional handover message indicating the number of the UEs supported by the target node; and
decide, by the source node, whether to continue with the conditional handover based on the received conditional handover message.

17. The moving node of claim 11, wherein
based on a group of UEs performing handover, the controller is configured to:
transmit, by the source node, a handover request message along with information to one or more target nodes, wherein the information indicates the number of a plurality of UEs and associated capability of the plurality of UEs in the group of UEs;
determine whether the one or more target nodes support the handover for the group of UEs based on the received information; and
perform the handover for the group of UEs based on the determination.

18. The moving node of claim 17,
wherein the controller, for performing the handover for the group of UEs connected to the moving node, is configured to:
accept, by a target node from the one or more target nodes, the handover request message;
perform, by the target node, admission control of the moving node and group of UEs connected to the moving node;
send, by the target node, an acknowledgment message indicating the handover is completed, wherein the acknowledgment message includes an RRCreconfiguration message;
forward, by the source node, the RRCreconfiguration message to the moving node and;
configure the handover for the group of UEs based on the received RRCreconfiguration message.

19. A moving node configured to perform dual active protocol stack (DAPS) for a group of user equipments (UEs) connected to a moving node in a wireless communication system, the moving node comprises:
a transceiver; and
a controller configured to control the transceiver,
wherein the controller is configured to:
transmit, by a source node, a DAPS handover request message along with information to one or more target nodes, wherein the information indicates the number of a plurality of UEs and associated capability of the plurality of UEs in the group of UEs;
determine whether the one or more target nodes support the DAPS handover for the group of UEs based on the received information; and
perform the DAPS handover for the group of UEs based on the determination.

20. The moving node of claim 19,
wherein the controller, for performing the DAPS is further configured to:
create a medium access control (MAC) entity for the target node;
establish a radio link control (RLC) entity and an associated dedicated traffic channel (DTCH) logical channel, backhaul logical channel or RLC entity, backhaul logical channel (BH-RLC-ChannelConfig), and the corresponding RLC configuration (RLC-Config) for a target for each data radio bearer (DRB) or backhaul RLC channel configured with DAPS;
reconfigure a packet data convergence protocol (PDCP) entity with separate security and a robust header compression (ROHC) functions for the source node and the target node;
associate the reconfigured PDCP with the RLC entities, wherein the RLC entities are configured by the source node and target node; and
retain the rest of the source node configurations until the release of the source node.
